(19) United States
(12) Patent Application Publication
(10) Pub. No.: US 2003/0078738 A1
(43) Pub. Date: Apr. 24, 2003

(54) Method and apparatus for detecting outliers in biological/parmaceutical screening experiments

(76) Inventors: Lucien Joseph Maria Rosalia Wouters, Turnhout (BE); Michael Franz-Martin Engels, Beerse (BE); Mark Beggs, Herdfordshire (GB)

Correspondence Address: Philip S Johnson, Johnson & Johnson, One Johnson & Johnson Plaza, New Brunswick, NJ, 08933-7003, US

(21) Appl. No.: 10/257,167

(22) PCT Filed: Apr. 11, 2001
(86) PCT No.: PCT/EP01/04126

(30) Foreign Application Priority Data
Apr. 12, 2000 (EP) 00201319.1

(51) Int. Cl. G01N 31/00

(52) U.S. Cl. 702/22

(57) ABSTRACT

A new method and apparatus for detecting outliers, more specifically false-negatives and/or false-positives, in pharmaceutical mass screening experiments is provided which utilizes chemical descriptor methodology in conjunction with supervised learning techniques. This method employs the latent structure-activity relationship between the chemical compounds and the biological activity for the detection of such outliers. The method is applicable to individual compounds as well as to pools or mixture of compounds.

The present invention relates to the development of new chemical compositions and compounds by the use of an improved screening technique as well as to apparatus suitable for carrying out the method. The present invention finds particularly advantageous use in high throughput screening of chemical compound libraries.

### TECHNICAL BACKGROUND

High throughput screening (HTS) of chemical compound libraries is considered as a key component of the lead identification process in many pharmaceutical companies and may also be used for the identification of chemical compositions in many other technical fields such as for the identification of herbicides, bactericides, insecticides, fungicides, vermicides. Such companies have established large collections of structurally distinct compounds, which act as the starting point for drug target lead identification programs. A typical corporate compound collection now comprises between 100,000 and 1,000,000 discrete chemical entities. The challenge is to quickly identify those compounds that show activity against a particular biological target. Compounds that show appropriate activity may ultimately form the basis of a lead optimization program aimed at optimizing the biological activity by modification of the chemical structure.

While a few years ago a throughput of a few thousand compounds a day and per assay was considered to be sufficient, pharmaceutical companies nowadays aim at ultra high throughput screening techniques with several hundreds of thousands of compounds tested per week. This goal has been attained by the widespread introduction of robotic systems, miniaturization, and data handling software into the screening process. Specialized groups have been set up in order to utilize these different types of technologies. This has led to the notion that screening is more like a production process with an industrial rather than scientific research focus.

Different actions/measures are required to enable the testing of these huge numbers of compounds as compared to those traditionally employed in low and medium throughput screens. For example, traditional low and medium throughput experiments are performed by screening the test compounds as multiple replicate samples. This option is often not open to HTS experiments for reasons of cost, resources and time. A typical corporate compound collection may be contained within 1000 to 5000 96-well microplates where each compound is represented by a single sample. Screening costs are typically $0.50 to $2.00 per compound and assay. The additional overhead in time and money required to test a compound collection of this size in duplicate or triplicate makes this an unrealistic proposal. In addition, limited resources for biochemicals such as recombinant proteins represent an additional parameter to limit the number of measurements to the absolutely minimum. Besides these restraints, the high level of automation that is employed has the effect that screening operators are not as aware of errors or system malfunctions as they would be if they were performing the screen manually. The widespread use of high speed automated reagent dispensers and robotic pipetting instrumentation, for example, has the consequence that the human operators are not able to check whether a reagent was dispensed into all the wells of the microtiter plate. This type of error results in the appearance of a systematic error across one or more microtiter plates. In recent years, software packages have been developed that either on-line monitor the performance of the running system or helps the screening operators to identify erroneous measurements after completion of parts of the screen. These software packages highlight systematic errors arising within single microplate or within a series of adjacent microplates. As a result of these developments, it is now possible to eliminate systematic errors arising, for example, from malfunctioning reagent dispensers or signal detection failures, from HTS data sets.

Despite the incorporation of these systems, the detection of outliers still presents a significant problem in the quality control of the screening process. Outliers in the context of this invention are defined as test samples whose recorded activity state differs from their actual state of activity. For example, false-positive outliers, also referred to as false-hits or false-actives, are test samples which originally being recorded as actives are actually identified as inactive test samples. On the other hand, false-negatives are test samples that are actual actives but which have not been picked up by the original screening experiment. Both types of outliers can have a significant impact on the success and efficiency of a screening campaign. A high rate of false-positives can consume significant chemistry and biology resources in futile hit confirmation attempts. False-negatives, however, can present a wrong picture of the inherent structure-activity relationship to the chemists who is working with the results of such a screen. Finally, a false-negative can mean a missed opportunity and, ultimately, a missed potential drug lead.

The occurrence of outliers can be related to a wide range of physical sources. First, the intrinsic variation of the screen itself, i.e. the biological preparation, forms the first source with the tendency to become more sensitive to outlier generation the more complex the biological system becomes. Second, random variations in physical components of the screening system like dispensers, robotic pipetting devices, and signal detection units, can contribute to the development of outliers. Third, single event incidences like sporadic malfunctions of a single system component form the most serious threat in screening operations.

Numerous theoretical treatments for the detection of outliers can be found in the statistics literature. However, in the context of pharmaceutical mass screening, only those methods have been applied that are fast and allow a high degree of automation. The article by Lutz et al “Statistical Considerations in High Throughput Screening”, Network Sci. 1996 [electronic publications] provides a good description of the current state of the art. Classical outlier detection methods used in pharmacological screening rely on the use of replicates. The most often applied methods for finding outliers are by Hawkins, and Bradu, by Rocke and Woodruff or by Atkinson. However, the use of replicates is not always an option due to cost and time constraints as mentioned above.

In summary, all prior-art approaches use only the measured response values, i.e. the biological activity, for the detection of potential outlier candidates. That is they used standard statistical techniques to determine if there are systematic correlation errors in the data.

The following documents may be useful in understanding the present invention:

M. W. Lutz, et al. “Statistical Considerations in High Throughput Screening” Network Sci. [electronic publication] 1996, http://www.netsci.org/Science/Screening/feature05.html.

M.Omatsu et al. “Quantitative Structure-Activity Studies of Pyrethroids” Pestic. Biochem. Physiol. 1991, 41(3), 238-249.

D. J. Svengaards et al. “Empirical modeling of an in vitro activity of polychlorinated biphenyl congeners and mixtures” Environ. Health Perspect 1997, 105 (10), 1006-1115.

D. M. Rocke and D. L. Woodruff “Multivariate Outlier Detection” Computing Science and Statistics 1994, 26, 392-400.

D. M. Hawkins, D. Bradu, and G. V. Kass “Location of several outliers in multiple-regression data using elemental sets”

Technometrics 1984, 26(3), 197-208.

J. Major “Challenges and Opportunities in High Throughput Screening: Implications for New Technologies” J. Biomol. Screen. 1998, 3, 13-?.

M. Entzeroth “Real-time scheduling and multitasking at the computer level, management of unplanned situations—a practical approach” Lab. Auto. Inf. Management 1997, 33, 87-92.

McCullagh, P., Nelder, J. A. Generalized Linear Models. 2^{nd} Ed. Chapman & Hall, London, UK, 1989

Hosmer, D., Lemeshow, S. Applied Logistic Regression Analysis. J. Wiley & Sons, New York, N.Y., 1989

Agresti, A. Categorical Data Analysis. J. Wiley & Sons, New York, N.Y., 1990

Ripley, B. D. Pattern Recognition and Neural Networks. Cambridge University Press, Cambridge, UK, 1996

Day, N. E. and Kerridge, D. F. “A general maximum likelihood discrirninant” Biometrics 1967, 313-323.

Newton, C. G. Molecular Diversity in Drug Design. in “Application to High-Speed Synthesis and High-Throughput in Molecular Diversity in Drug Design” eds. P. M. Dean & R. A. Lewis, Kluwer Academic Publishers, 1999.

Bishop, C. M. Neural Networks for Pattern Recognition, Oxford University Press, 1995.

Quinlan, R. C4.5: Programs for Machine Learning, Morgan Kaufman Publishers, 1992.

Zupan, J. and Gasteiger, J. Neural Networks in chemistry and drug design. Wiley-VCH.

Weiss, S. M. and Kulikowski, C. A. Computer Systems that Learn.Morgan Kaufmaan Publishers, 1991.

One object of the present invention is to improve the detection of outliers, in screening tests, particularly the improved detection of false positives and/or false negatives.

### SUMMARY OF THE INVENTION

In one aspect of the present invention additional use is made of the information residing in the chemical structures of tested compounds in order to detect outlier candidates, that is potential false positives and/or potential false negatives. In a further step these candidates may be re-tested in order to determine whether they are true false positives or negatives.

The present invention provides a method for identifying an outlier candidate using a quantitative structure-activity relationship in the results of a screening assay for a set of candidate chemical objects, comprising:

forming a categorized dataset for biological or chemical activity values for the candidate chemical objects;

generating a structure-activity relationship (SAR) dataset for the tested candidate chemical objects; and

analysing the SAR dataset to determine at least one outlier candidate, the outlier candidate being falsely categorized in the categorized dataset.

The present invention makes use of the fact that the chemical structures of a series of molecules which are related because they all exhibit some activity in the biological system of interest have a common aspect or structure which is important to the activity. The present invention makes use of this inherent but possibly latent relationship between structural and/or physicochemical features and the activity in a novel way by developing a quantitative model expressing the relationship between the biological activity and the structural or physicochemical parameters and using this model to detect those test results which would be expected to have a low probability of being correct.

The present invention includes the use of a quantitative structure-activity relationship for the identification of at least one outlier candidate, e.g. a potential false positive or a potential false negative when the categorization is a simple binary one, in a screening assay for biologically active compounds. The structure-activity relationship is preferably based on a molecular model used to describe each compound to be tested. The structure-activity relationship preferably includes a plurality of identifiers or descriptors used to describe each compound to be tested, each identifier or descriptor being related to measured or calculated characteristics of the relevant compound or combination thereof. Preferred methods for analyzing the activities are based on a concept learning system. Regression, discriminant analysis, decision trees, and neural networks may be used for the analysis of the activities of the compounds to be tested and the molecular model. The regression analysis may be based on a generalized linear model such as logistic regression analysis based on a binomial or Bemouilli distribution.

The present invention may also provide a method for the identification of at least one outlier candidate in a screening assay for the biological activity of a plurality of candidate chemical objects, the outlier candidate being determined from the measured activity of each chemical object tested in the assay, comprising the steps of:

defining each chemical object tested in the assay by a set of parameters relating to a molecular model of the structure of each chemical object; and

performing an analysis of the activity values and the sets of parameters to determine for each chemical object whether the activity level associated with the specific chemical object lies outside a predetermined probability. The defining step may comprise:

a) calculating and assembling a set of descriptors for each chemical object that was tested in the screening assay;

b) assembling the results of step a) into a vector for each chemical object followed by the step of:

c) assembling all vectors related to a chemical object into a matrix with each row of the matrix corresponding to a chemical object and each column corresponding to a descriptor or vice versa. Optionally, the number of chemical objects or descriptors may be reduced depending upon their statistical relevance, for instance by principal component analysis or factor analysis.

The method may also include the of step quantizing the measured activity into a plurality of classes, preferably into two classes, that is either biologically active or inactive chemical objects, and assigning one of the classes to each chemical object. To identify an outlier candidate a probability value that each chemical object belongs to one of the activity classes may be calculated. The probability calculating step may be, for instance one of regression, discriminant analysis, the use of a decision tree and the use of a neural network. The regression step may include one of least mean squares and linear logistic regression. Finally, the probability that a chemical object belongs to an activity class is compared with the measured activity class for that chemical object, and marked as an outlier candidate if the there is a high probability that the chemical object does not belong to that measured activity class. For example, the chemical object is marked as an outlier candidate if the probability of not belonging to the measured activity class is above a threshold value.

The method may be implemented in a computer program with software code and stored on a computer readable medium and may be executed on a computer system.

The present invention may also provide an apparatus for the identification at least one outlier candidate from the results of a screening assay for the biological activity of a plurality of candidate chemical objects, the apparatus comprising:

an input device for inputting the activities of the chemical objects determined in the assay and for inputting definitions of each chemical object tested in the assay including a set of parameters relating to a molecular model of the structure of each chemical object; and

a processing engine for performing an analysis of the activity values and the sets of parameters to determine for each chemical object whether the activity level associated with the specific chemical object lies outside a predetermined probability.

The present invention includes a method for the identification at least one outlier candidate in a screening assay for the biological activity of a plurality of candidate chemical objects, the outlier candidate being determined from the measured activity of each chemical object tested in the assay, comprising the steps of:

loading into a local terminal the descriptions of a plurality of chemical objects and the activity result of the assay for each chemical object;

transmitting the descriptions and activity results to a remote location for carrying out the method in accordance with the present invention, and receiving at a local location a definition of at least one outlier candidate.

In a further aspect of the invention, there is provided a method of identifying at least one outlier candidate in the results of a screening assay for a plurality of chemical compounds, the method comprising the steps of

(a) generating a set of descriptors representative of at least one feature of each of the plurality of chemical compounds that were the subject of the screening assay;

(b) generating, for each of the plurality of chemical compounds, a descriptor matrix including data points each defining the predicted value of the or each feature represented by a respective descriptor;

(c) generating a corresponding empirical dataset for the chemical compounds that were the subject of the screening assay, the empirical dataset containing categorized values for the potency of each chemical compound in the assay;

(d) merging the empirical dataset with the descriptor matrix to generate a structure activity (SAR) dataset;

(e) applying a statistical analysis to the SAR dataset; and

(f) identifying, on the basis of that statistical analysis of the SAR dataset, at least one outlier candidate representing a corresponding at least one chemical compound in the empirical dataset which has been incorrectly categorized therein.

Still further, the invention may provide a method of identifying at least one outlier candidate in the results of a screening assay for a plurality of chemical compounds, the method comprising the steps of:

(a) generating, at a first, remote location, a set of descriptors representative of at least one feature of each of the plurality of chemical compounds that were the subject of the screening assay;

(b) generating, at a second local location, for each of the plurality of chemical compounds, a descriptor matrix including data points each defining the predicted value of the or each feature represented by a respective descriptor;

(c) removing those elements of the descriptor matrix which are determined to be redundant or linearly dependent;

(d) generating a corresponding empirical dataset for the chemical compounds that were the subject of the screening assay, the empirical dataset containing categorized values in binary format for the potency of each chemical compound in the assay;

(e) merging the empirical dataset with the descriptor matrix to generate a quantised structure activity (QSAR) dataset;

(f) applying a concept learning analysis including one of regression analysis, discriminant analysis, decision trees and neural networks to the QSAR dataset; and

(g) identifying, on the basis of that concept learning analysis of the QSAR dataset, at least one outlier candidate representing a corresponding at least one chemical compound in the empirical dataset which has been incorrectly categorized therein.

In yet another aspect of the invention, there is provided an apparatus for identifying at least one outlier candidate in the results of a screening assay for a plurality of chemical compounds, comprising:

a first processor for generating a set of descriptors representative of at least one feature of each of the plurality of chemical compounds that were the subject of the screening assay;

a second processor for generating, for each of the plurality of chemical compounds, a descriptor matrix including data points each defining the predicted value of the or each feature represented by a respective descriptor, and for generating a corresponding empirical dataset for the chemical compounds that were the subject of the screening assay, the empirical dataset containing categorized values for the potency of each chemical compound in the assay;

the apparatus comprising means for merging the empirical dataset with the descriptor matrix to generate a structure activity (SAR) dataset;

means for applying a statistical analysis to the SAR dataset; and

means for identifying, on the basis of that statistical analysis of the SAR dataset, at least one outlier candidate representing a corresponding at least one chemical compound in the empirical dataset which has been incorrectly categorized therein.

In a further aspect of the invention, there is provided an apparatus for identifying at least one outlier candidate in the results of a screening assay for a plurality of chemical compounds, comprising:

a first processor for generating, at a remote location, a set of descriptors representative of at least one feature of each of the plurality of chemical compounds that were the subject of the screening assay;

a second processor for generating at a second, local location, for each of the plurality of chemical compounds, a descriptor matrix including data points each defining the predicted value of the or each feature represented by a respective descriptor, for removing those elements of the descriptor matrix which are determined to be redundant or linearly dependent, and for generating a corresponding empirical dataset for the chemical compounds that were the subject of the screening assay, the empirical dataset containing categorized values in binary format for the potency of each chemical compound in the assay;

the apparatus being further arranged to merge the empirical dataset with the descriptor matrix to generate a quantised structure activity (QSAR) dataset; to apply a concept learning analysis including one of regression analysis, discriminant analysis, decision trees and neural networks to the QSAR dataset; and to identify, on the basis of that concept learning analysis of the QSAR dataset, at least one outlier candidate representing a corresponding at least one chemical compound in the empirical dataset which has been incorrectly categorized therein.

Further embodiments of the present invention are defined in the attached claims. The present invention will now be described with reference to the following drawings.

### BRIEF DESCRIPTION OF THE FIGURES

FIG. 1 is a flow diagram of the method for the detection of outlier candidates in screening experiments that involves the use, generation, and processing of chemical descriptors, quantization of biological activity data, combination of both types of information in a QSAR table, the analysis of this QSAR table by means of a concept learning system, and, finally, post-processing of the output of the learning system analysis in order to rank candidate outliers for subsequent validation experiments.

FIG. 2 shows the distribution of the measured biological activity expressed as % inhibition versus control at 10-5 M for the 89,539 compounds in the example data set.

FIG. 3 is an illustration of how the QSAR table which forms the final input to the logistic regression analysis, was generated for the example data set from input structures and biological activity data. FIG. 3A shows the quantization of the numerical biological response (%-control) into two activity categories (1 equals active, 0 corresponds to inactive). FIGS. 3B and C show how the original key matrix (FIG. 3B) consisting of 166 keys per compound is transformed via principal component analysis into a matrix (FIG. 3C) in which compound is represented by 158 principal components. For sake of illustration, only the first 30 compounds are shown for each procedure step. Finally, the two matrices are merged into one table (not shown) using the compound identifier as key.

FIG. 4 is an illustration of the output of the logistic regression analysis. Column 1 refers to the compound identifier, column 2 shows the original % inhibition value measured in the first screening experiment, column 3 shows the activity status deferred from the %-inhibition value and the predefined threshold, column 4 and column 5 show the calculated probability to be inactive (P(0)) or active (P(1)). For reasons of confidentiality, compounds received an arbitrary compound name.

FIG. 5 shows an illustration of the final table used for the detection of false-negative outlier candidates. Headers correspond to that described in FIG. 4. Using the output table shown in FIG. 4, compounds with measured activity category “1” were removed and the table was sorted according to ascending probability using P(1) as sorting key. The top 1586 compounds in that list were suggested as potential false-negative outliers. The number of candidates were chosen based on the capacity of the follow-up and validation screen.

FIG. 6 shows the expected number of false-negatives calculated for the example data set as a function of the segment size. The segment size is referring to a rank list of initially inactive compounds that are ordered according to their probability to be active. For example, according to this plot the expected number of false-negatives by testing the top 1583 compounds of the rank list is 254.

FIG. 7 shows the distribution of the measured biological activity expressed as % inhibition versus control at 10-5 M for the all 98138 compounds in a second example data set.

FIG. 8 shows the distribution of the measured biological activity expressed as % inhibition versus control at 10-5 M for the 730 most probable false-negative outlier candidates of the second data set.

### DEFINITIONS

Outlier: a real outlier in the context of this invention is a candidate chemical object (or test sample) whose recorded, measured activity class does not correspond to its actual activity class.

Outlier candidates are chemical objects (or test samples) suggested by the method described in this invention as potential outliers.

Candidate chemical objects: candidate chemical objects refers to all the chemical objects tested in an assay, wherein chemical objects may comprise discrete chemical compounds, i.e. chemical molecules and/or pools or mixtures of chemical compounds.

Probability of belonging to an activity class: In the step of identifying a candidate outlier the probability that a candidate chemical object belongs to a given activity class is compared to the measured activity class for said chemical object and marked as an outlier candidate if there is a high probability that the chemical object does not belong to the given activity class. <<High >> may refer to a threshold value.

Statistical decision rules for determining activity classes: these may be based on methods such as percentiles, X-o-rule, hypothesis testing methods (for example Student t-test) or similar.

Descriptors: descriptors in the context of the present invention relates to a combination of measured and/or calculated characteristics of the candidate chemical objects wherein said calculated characteristics comprise physicochemical and structural characteristics such as logP, electrotopological indices and structural keys, obtainable using computer based methods such as ClogP, AlogP, CMR or MACCS-keys, or similar and wherein said measured characteristics comprise physicochemical, pharmacophoric and structural characteristics such as solubility, melting point, molecular mass, pKa, known therapeutical class, binding affinities to target(s) expressed for example as pIC₅₀, pKi, or similar.

### DESCRIPTION OF THE ILLUSTRATIVE EMBODIMENTS

The present invention relates to a method and apparatus for identifying at least one outlier candidate in an assay for the activity of a plurality of candidate chemical objects. A categorized dataset for the activity values of the candidate chemical objects is generated and a descriptor matrix for the chemical objects tested in the assay is defined. The descriptor matrix is merged with the categorized dataset into a structure-activity relationship (SAR) dataset and this SAR dataset is analysed to identify outlier candidates. The generation of the categorized dataset may comprise the steps of categorization of the activity values of the candidate chemical objects into a number of discrete activity classes using an automatically applied threshold based on statistical decision rules, or categorization of the activity values of the candidate chemical objects into a number of discrete activity classes using user defined thresholds. Defining a descriptor matrix may comprise the steps of selecting vectorized descriptor data for each candidate chemical object tested in the assay from a vectorized descriptor dataset and assembling all vectors related to the candidate chemical objects tested in the assay into a matrix with each row of the matrix corresponding to a chemical object tested in the assay and each column corresponding to a descriptor or vice versa. Optionally, the resulting descriptor matrix can be optimised for redundancy and linear relationships using multivariate analysis techniques such as principal component and factor analysis. Principal component analysis provides a way of identifying vectors for representing a multi-dimensional space without redundancy which can introduce unwanted complexity.

The vectorized descriptor dataset may be generated for a candidate chemical object by means of putting the chemical object data, such as chemical structural attributes, biological attributes, and/or physicochemical information into a descriptor generating engine, wherein said descriptor generating engine calculates a set of descriptors for the inputted objects. Computer based methods such as ClogP, CMR, MACCS-keys or Electrotopological Indices can be used. The results of the descriptor programs for each of the chemical objects are stored in a computer retrievable format, optionally being stored in standard database systems such as ORACLE, ODR, Microsoft Access, in a set of different databases or a data warehouse such as Informax, SAS Warehouse Administrator. The analysis of the SAR-dataset, to identify outlier candidates, may comprise the steps of calculating for each of the candidate chemical objects the probability value that the relevant candidate chemical object belongs to a certain activity class and storing said probability values in a prediction dataset. The number of activity classes may be limited to two. Falsely classified outlier candidates, e.g. false positive or negative outlier candidates may be determined from the prediction dataset. Outlier candidates for a predefined activity class may be identified from the prediction dataset by means of reducing the prediction dataset to the candidate chemical objects with a measured activity belonging to a predefined activity class and selecting from this reduced prediction dataset the outlier candidates with the highest probability of not belonging to this predefined activity class. For example, for false positives, the originally as inactive recorded candidate compound objects are removed from the prediction dataset and the outlier candidates selected which have the highest probability of not being active from this reduced prediction dataset. False negative outlier candidates can be identified from the prediction dataset by removal of the candidate compound objects that were originally recorded to be active from the prediction dataset and selecting the outlier candidates with the highest probability of being active from this reduced prediction dataset.

The probability value may be calculated using a concept learning system, such as for example regression, discriminant analysis, decision trees or neural networks. In a further aspect of the invention the regression analysis method is a generalized linear model such as logistic regression based on binomial or Bemouilli distribution using logit link function, probit, complementary log-log link function or other link functions; and the log-linear models based on the Poisson distribution. The selection of the outlier candidates may be based on a user defined threshold, or by taking a predefined number of candidate compound objects that have the highest probability of not belonging to the relevant activity class.

The present invention may also provide an apparatus for the identification of at least one outlier candidate in an assay for the activity of a plurality of candidate chemical objects, the apparatus comprising: a generator for generating a categorized dataset, a descriptor matrix generator, an SAR-dataset generator and an outlier evaluator. The categorized dataset generator may comprise a means for inputting the activity data of the candidate chemical objects, said activity data optionally being stored on an activity data storage device, a means for categorizing the activity data of the candidate chemical objects, said activity data optionally being read from the activity data storage device, into a categorized dataset using a method according to the invention, wherein said categorized dataset is optionally stored in the categorized data storage means. The descriptor matrix generator may comprises a means for inputting chemical object data of candidate chemical objects, said chemical object data optionally being stored on the chemical object data storage means, a means for generating a vectorized descriptor matrix for the candidate chemical objects, wherein the chemical object data are uploaded into a descriptor generating engine, calculating for each chemical object a vectorized descriptor matrix according to a method of the invention, said vectorized descriptor matrix optionally being stored on the vectorized descriptor matrix storage means. The SAR dataset generator may comprise a means for uploading the vectorized descriptor matrices of the candidate chemical objects and the categorized data of the candidate chemical objects into a structure-activity relationship (SAR) dataset generating engine, a structure-activity relationship (SAR) dataset generating engine for merging the uploaded vectorized descriptor matrices of the candidate chemical objects with the categorized data of the candidate chemical objects into a SAR-dataset, said SAR-dataset optionally being stored on the SAR-dataset storage means. The outlier evaluator may comprises a means for assigning probability values to each of the candidate chemical objects in the SAR-dataset, said SAR-dataset optionally being read from the SAR-dataset storage means, that said candidate chemical object belongs to one of the activity classes, and wherein the probability values are optionally being displayed on an output means and/or stored on a storage means, a means of ranking the candidate chemical objects according to their probability of being incorrectly identified in an activity class, an input device to select at least one of the activity classes; and an output means for the expected number of outlier candidates s in the selected activity classes as a function of the number of candidate chemical objects.

The methods and apparatus used in the present invention find particular advantageous use in the validation and detection of outliers in mass screening experiments like high-throughput screening (HTS) where the cost per compound prohibits the use of replicate samples for each compound. In a first preferred embodiment, the method can be applied to large bodies of data generated as a result of (ultra)-high throughput screening in which the compounds are either tested as single entities or in mixtures. The size of the HTS data set, its complexity as well as its structural diversity means that the application of quantitative structure-activity relationship (QSAR) methods like Partial Least Square Analysis (PLS) or Multiple Linear Regression analysis (MLR) are less preferred. Although not excluded from the present invention, these types of methods show good results when correlating the measured activity of a limited structurally similar set of compounds. However, they generally fail to model the quantitative structure-activity relationship of large and structurally diverse data sets as usually encountered in HTS experiments. In addition, the biological activity of test compounds tested in high-throughput screens are most often expressed in form of a binary activity vector, i.e. compounds are either considered as active or inactive. This poses a further complication and renders the use of these QSAR techniques less useful.

Concept learning systems in machine learning (see Weiss & Kulikowski) encompass a group of supervised learning systems for the classification and prediction of observations based on a set of attributes/descriptors. A typical concept learning system is designed to work with some general model such as decision trees, a discriminant function, or a neural net. Various implementations of concept learning systems exist in chemistry (see Zupan & Gasteiger) but none have been adapted to the specific problem of detecting outliers in diverse and large sets of compounds. The present invention features a new method, preferably computer based, as well as an apparatus that uses the activity-structure relationship in combination with a concept learning system (or supervised learning system) in order to detect outliers in screening experiments. One suitable activity-structure relationship is chemical descriptor technology.

The method according to the present invention relies upon the novel utilization of the latent structure-activity relationship which is characteristic for pharmaceutical-chemical data sets. The biological activity is expressed on a quantized scale, for example a binary scale. An aspect of the method is the use of concept learning systems. The molecules in the HTS data set are represented by a set of chemical descriptors which can capture a variety of different chemical characteristics including both topological and physicochemical or pharmacophoric features. Based on the chemical descriptors and the initially measured biological activity a classification model is developed that predicts the degree of affiliation for each compound in the data set, expressed in probability values between 1 and 0, to either the group of active or inactive compounds. If the discrepancy between the calculated probability and the actual measured response is high, the molecule is indicated as a potential outlier. Using this procedure, several hundreds or even thousands of molecules can be grouped together and ranked according to their likelihood of being potentially false-positives and/or false-negatives.

This invention may be implemented in an illustrative embodiment by a plurality of computer programs, which are loaded into and executed on one or more computers or computer systems. For example, the computer may be a workstation such as a SGI Octane. The computer programs may contain software code for execution on a computer or computer system. The software code may be stored on a suitable medium such as on computer hard disks or on one or more CD-ROM's. The methods according to the present invention may be carried out on a server located on a LAN, a WAN or connected to a near terminal by a telecommunication link such as the Internet or an Intranet. The list of outliers may be received at the near terminal after calculation thereof on the remote server. This invention provides a powerful tool or method for determining outlier candidates in screening experiments, and has particular utility for high throughput screening.

It is a further object of the invention to provide a method for predicting falsely categorised results of a screening assay comprising the steps of: forming a categorised training dataset for biological or chemical activity values for a training set of chemical objects subjected to a screening assay, generating a structure activity relationship dataset for the tested chemical objects, and analysing the SAR dataset to determine a predictor model for falsely categorised chemical objects in the categorised dataset,

forming a categorised second dataset for biological or chemical activity values for a second set of different chemical objects subjected to the same screening assay and, determining at least one falsely categorised chemical object in said categorised second dataset using said predictor model.

The method according to the above wherein the predictor model consists of;

using the descriptors for a particular chemical object tested in the second screening assay, determine the probability of it being in a particular activity class based on the result of the trained set, compare the measured activity of a particular chemical object in the second screening assay with the probability of a chemical object with these descriptors falling in this activity class, based on the comparison decide whether it is possible that the measured activity class is false.

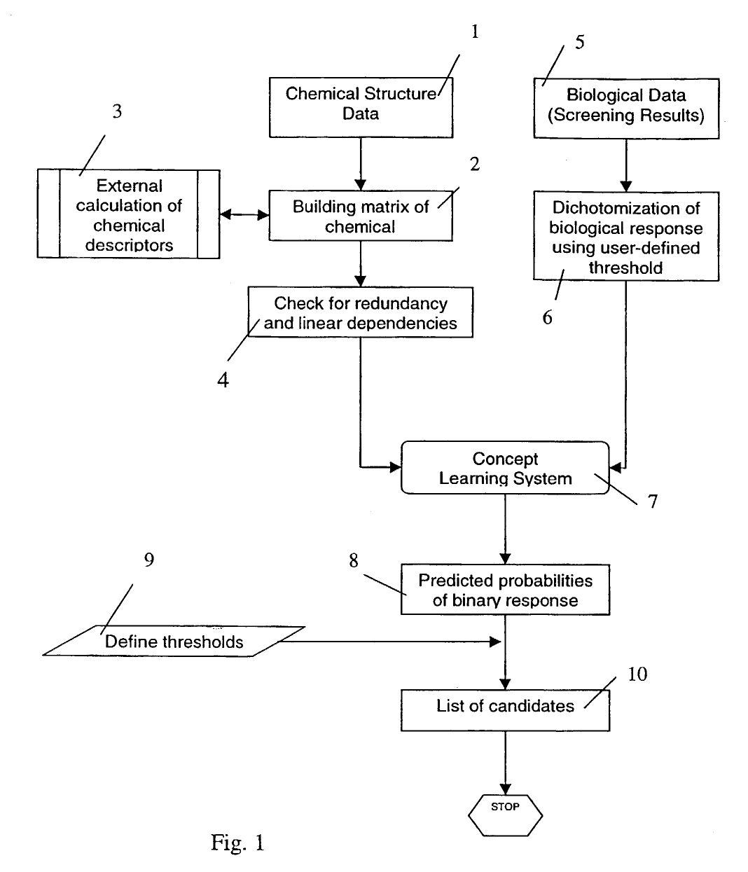

Referring to the drawings and, in particular, to FIG. 1, a method is disclosed for detecting potential outliers in screening experiments using concept learning systems in conjunction with chemical descriptor technology.

First (see FIG. 1), a set of descriptors is generated for each molecule that was subject of the screening experiment (step 1). Descriptors, in the invention are defined as any type of descriptive notation that, in the context of chemistry, are chemically interpretable, have enough detail that they can capture useful chemical structural or/and physicochemical information. Examples for typical descriptors that can form input for the presented invention are different types of binary fingerprints or structural keys, 1D descriptors of physicochemical parameters like ClogP, CMR, or molecular weight, or descriptors that encode pharmacophoric or steric information. The chosen descriptors are preferably calculated externally in step 3 (see FIG. 1) to allow an extremely high degree of flexibility in the use of this invention.

There are several reasons for carrying out the calculation of descriptors in an external step. First, considering the speed with which new descriptors are developed, the method in accordance with the present invention is flexible enough to allow the inclusion of new types of descriptors in order to adapt and improve performance and accuracy. Secondly, since the invention is not restricted to one particular computer platform, several types of descriptors can be generated in parallel even on different platforms increasing the performance and flexibility of the method.

The output of the external descriptor programs is parsed and the results of the calculations are stored in form of data triplets. Each triplet consists of the compound identifier of the compound, the type of descriptor that was used for the calculation, and the calculated value for that descriptor type. Data triplets can be easily stored on different types of database systems for fast retrieval and processing.

Once the external calculations are completed, the descriptors are combined and mapped to the respective compound (step 2, FIG. 1). As a result of this mapping procedure, an n×p matrix of descriptors is formed in which each of the p columns of the matrix refers to a particular descriptor type and each of the n rows to one molecule in the original data set. The matrix is augmented by the compound ID's associated with each molecule.

In the next step of the invention, step 4, FIG. 1, the n×p matrix of chemical descriptors is checked for redundancy and linear dependencies. A simple test procedure is used to eliminate redundant columns from the matrix, i.e. columns that are identical in each element such as for example columns which are all o or 1 for binary coded descriptor data. Standard principal component analysis or singular value decomposition is then applied in order to identify a set of orthogonal explanatory variables (principal components) that are linear combinations of the original input variables. The principal components are ranked according to the percentage of variance they capture from the variance of the original descriptor space. A minimum set of principal components is retained that express 100% of the variance of the original input matrix of descriptors. Alternatively, when the descriptor matrix consists of only binary coded data, elementary row operations on the matrix of crossproducts can be used to eliminate linear dependencies among the columns. In addition, for binary coded descriptor data, univariate association with the response data (see below) can be tested preliminary with a chi-square test for independence. Chemical descriptors having a p-value as low as 0.2 are considered candidate predictors for the next step of the invention. The transformed matrix, which is a result of either of the suggested procedures, will be equal or of smaller size than the original descriptor matrix.

In the meantime, an empirically database of the potency of each of the compounds in the screening experiment is assembled (step 5). If the potency of the compounds is expressed on an interval scale, a quantization of the potency values (step 6) into a number of discrete classes, for example into two distinct classes is performed by default. A given percentile of the potency value is generally used as splitting criterion. The resultant vector Y contains all the activities of the measured compounds encoded in binary format i.e. active compounds are expressed by a “1”, inactive compounds by a “0”. The default threshold can be overwritten by the operator who can input different splitting criteria which are then applied for binary quantization. The vector of binarised potency values Y is then merged with the transformed matrix of descriptors into a QSAR table.

In the next step (steps 7, 8 FIG. 1), a statistic analytical program is performed on the QSAR table to identify measured activities which are not consistent with the other results of similar compounds or chemical groups within the assay. This analysis may be performed in a concept learning system. For example, a regression analysis is performed between the descriptors and the activity levels in order to determine those results which lie outside an assumed inherent structure-activity relationship at a statistically significant level. One preferred regression analysis method is that of logistic regression analysis. Logistic regression (logistic discriminant analysis) is a statistical method for the analysis of categorical data. Let Yᵢ denote the dichotomized response of a compound. Represent the possible outcomes by 1 for a compound found active and 0 for a compound classified as inactive. It is assumed that Yᵢ is Bernoulli distributed. The probability πᵢ that the i^{th} compound was found active, can then be modeled as:

$$P ( {Y}_{i} = 1 ) = {π}_{i} = \frac{exp ( {β}_{0} + {\sum }_{k = 1}^{p} {β}_{k} {x}_{k} )}{1 + exp ( {β}_{0} + {\sum }_{k = 1}^{p} {β}_{k} {x}_{k} )} \qquad [ 1 ]$$

where β₀ . . . βₚ are the unknown parameters of the model and x₁ . . . xₚ the p explanatory variables of the compound that were retained in the previous step. For over-determined models as is the case in this application, it is often necessary to omit the intercept β₀. Model [eq. 1] is also called a generalized linear model with binomial distribution and logit link function. Alternative models that are also part of this invention are models based on the binomial or Bernoulli distribution using the probit (normit) and complementary log-log link function. When the explanatory variables are categorical as is the case here, log-linear models (Poisson regression), based on the Poisson distribution, are equivalent to logit models and are also part of this invention.

Model [1] is fitted to the data using standard statistical packages, yielding estimates of the parameters \hat{β}₀ . . . \hat{β}ₚ. In contrast to QSAR studies, the estimates of the parameters are not important, but rather the predicted probabilities \hat{π}ᵢ obtained from [eq. 1] by replacing the parameters by their estimates.

In the following step (step 9), the investigator sets up threshold values for the number of false negative n₁ and false positive n₂ compounds that he/she would like to retest or, alternatively, a predetermined value or a default value is assumed. The list of compounds is then sorted in descending order of predicted probability of being active (step 10). The first n₁ compounds of the list that initially were classified as inactive are candidates for retesting as false negatives. Conversely, the last n₂ compounds that initially were regarded as active are considered as false positives.

It is important to understand that not only discrete compounds can be subject of the present invention but also pools or mixtures of compounds. Conceptually, a mixture or pool of compounds, isomers, conformers, etc. can be considered as a linear interpolation of the descriptors in that pool and can be analyzed in the very same fashion than single entities. Broadly speaking, discrete compounds or individuals are data objects (an object that itself is not a mixture), but such pools are themselves also each a data object, which we refer to as a mixture object for greater clarity (i.e. an object that is itself a mixture). Whether an object is a data object or mixture object, the object is analyzed in the same fashion using descriptor assemblies and logistic regression analysis.

### EXAMPLE 1

The first example relates to the use of logistic regression analysis in conjunction with MACCS keys for the detection of false negatives in the results of a typical HTS experiment.

A tyrosine kinase screen was used to illustrate the effectiveness of the invention in detecting false-negative compounds. Within the screening experiment, 89,539 compounds were tested for their kinase inhibiting activity. The screen used the scintillation proximity technology on 96 well microtiter plates, the well concentration of the test compounds was uniformly 10-5 M. The biological potency of a test compound in the screen was expressed as a percentage of the control value. The concentration of the test compound is represented by the value zero. 100% control refers to an inactive potency state, 0% control means the compound is active. No replicate measurements were taken.

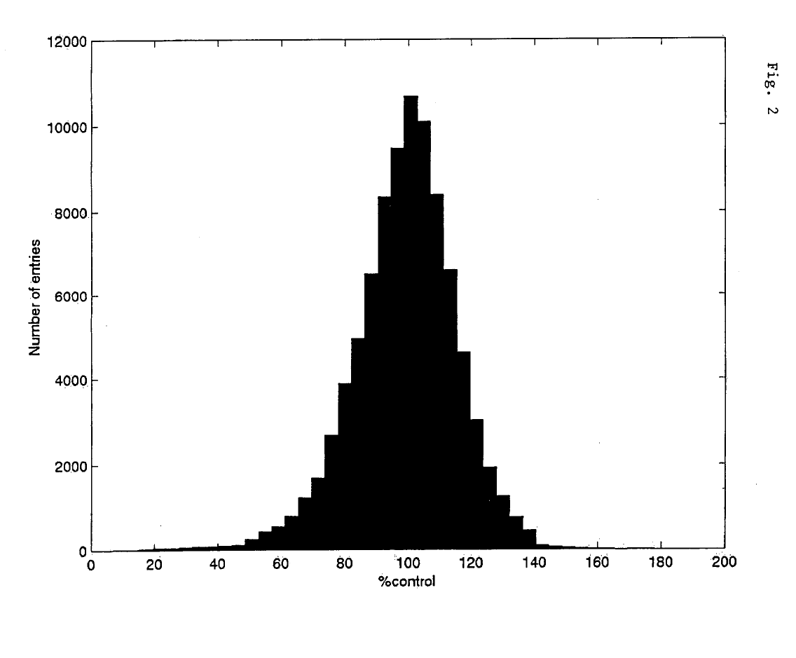

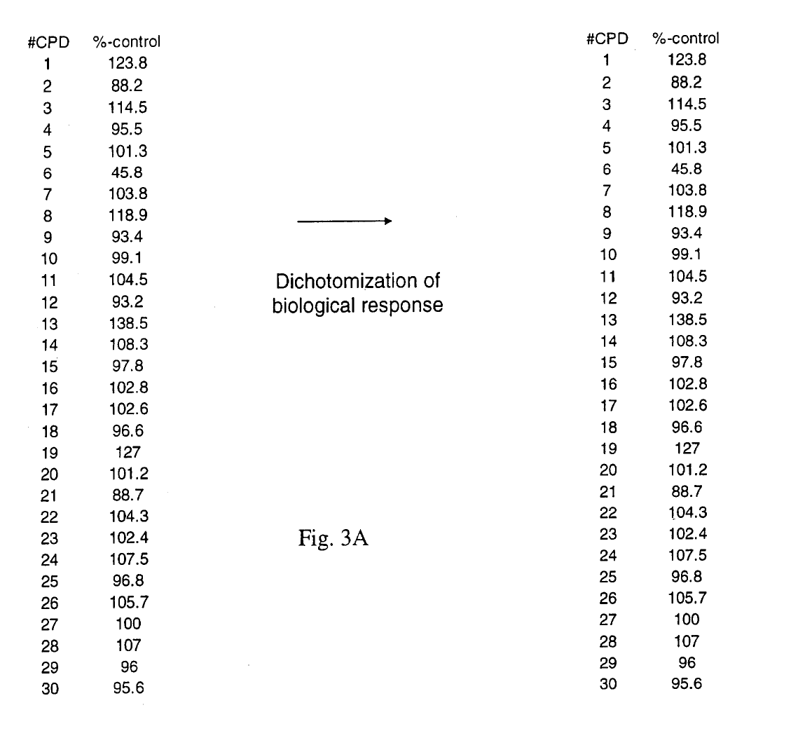

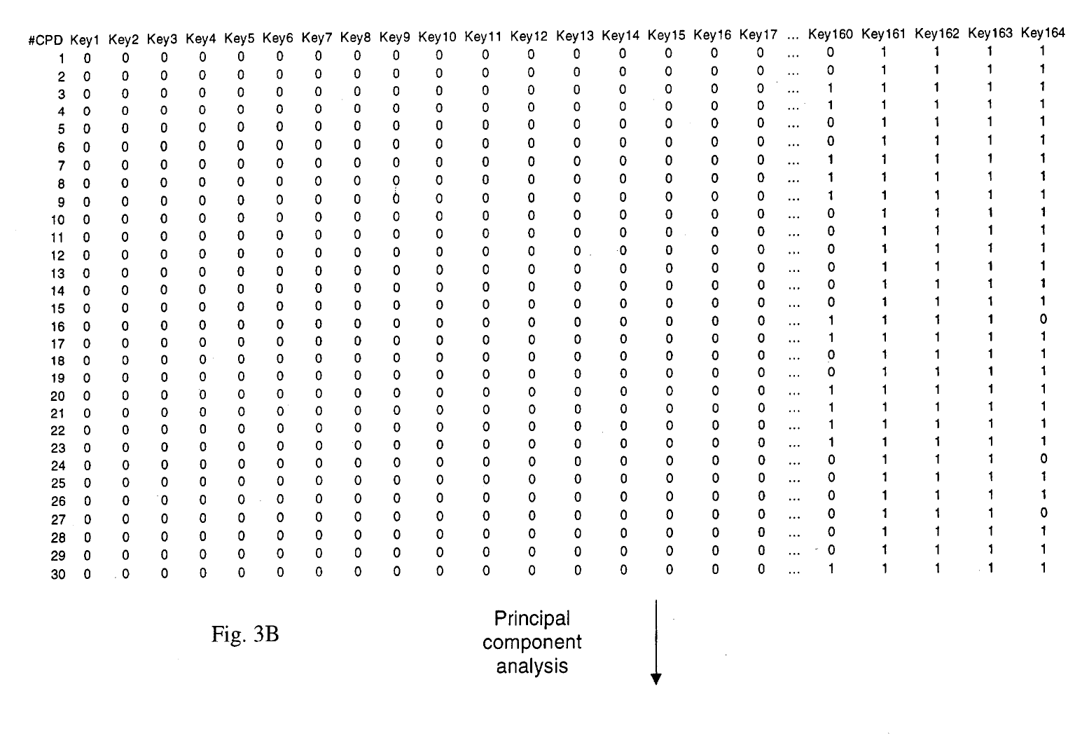

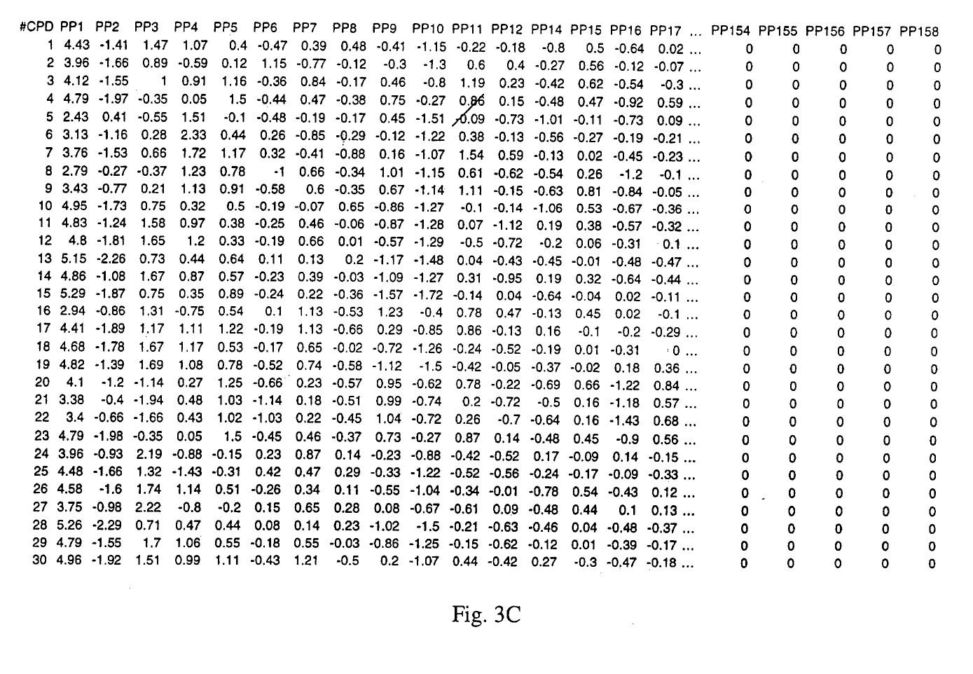

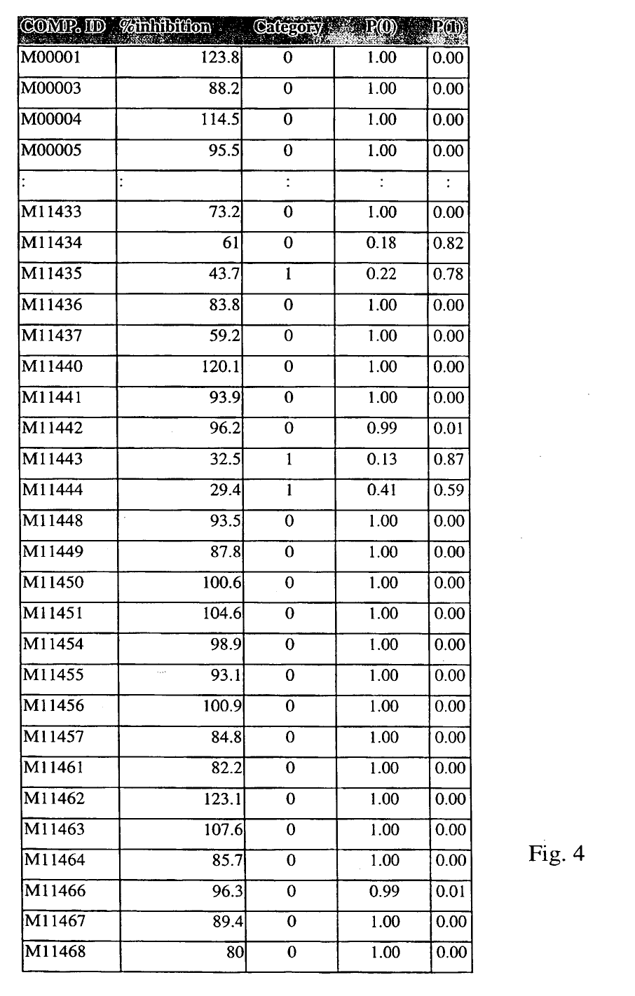

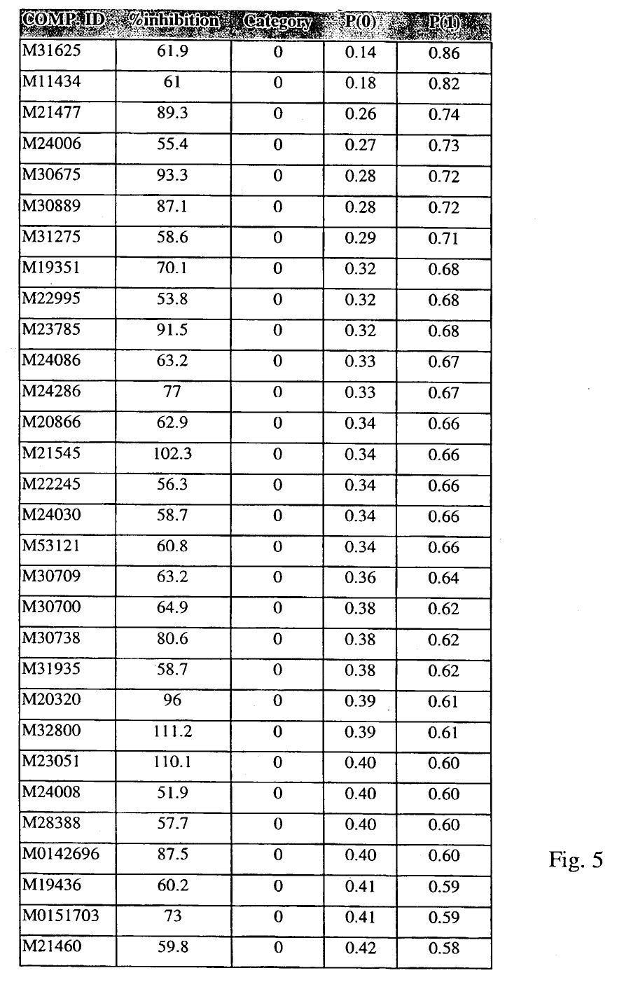

FIG. 2 shows a histogram of the distribution of measured potency in the example screen. The mean of the distribution occurs at 99.0% control, the standard deviation is 16.6% control, maximum and minimum percentage control are at 394.4 and −22.1%, respectively. The biological activity was dichotomized based on the following criterion: test compounds with a biological activity less than 50% control were considered as active, represented by a “1” in the QSAR table (FIG. 3A), all remaining compounds were considered as inactive, represented by a “0”. Based on this criterion, 653 compound were active, corresponding to a hit rate of 0.73%.

Structure or physicochemical property related keys were calculated for each compound in the data set. An example of such keys are the MACCS keys described, for instance, in the article by Ajay, et al. “Distinguishing between drugs and non-drugs”, J. Med. Chem., 1998, vol. 41(18), in particular table 1 on page 3316 and the related description on page 3315. As explained in this article 166 keys are used, commonly known as the ISIS fingerprint (available from SSKEYS, MDL Information Systems Inc., San Leandro, Calif., USA). Each key describes the presence (1) or absence (0) of a structural fragment in the relevant compound, the fragments being defined in a fragment dictionary.

In order to reduce the amount of computation, a procedure may be adopted to reduce the number of keys which describe a compound under test by selecting only those keys which show a statistical relevance, or by eliminating those keys which show a low statistical relevance. Hence, one aspect of the present invention is to use a key set which overdetermines any particular problem followed by an optimization step to eliminate those keys which do not have a high relevance. This increases the flexibility of the present invention and allows the method to adapt the molecular model used to a specific library-assay combination. One such optimization procedure which can be applied is principal component analysis. Principal component analysis is a technique known to the skilled person manipulating multi-dimensional data. In principal component analysis, components having a statistically weak relevance are eliminated. This procedure was applied to the 89539*166 descriptor matrix. According to this analysis, the content of the original descriptor matrix (FIG. 3B) can be expressed by 158 principal components, thus, the final transformed descriptor matrix consists of 89530 rows and 158 columns. The columns refer to the principle components. The principal component matrix was merged with the vector of dichotomized biological activities resulting in the final QSAR table (see FIG. 3C shows the first 10 rows of that table).

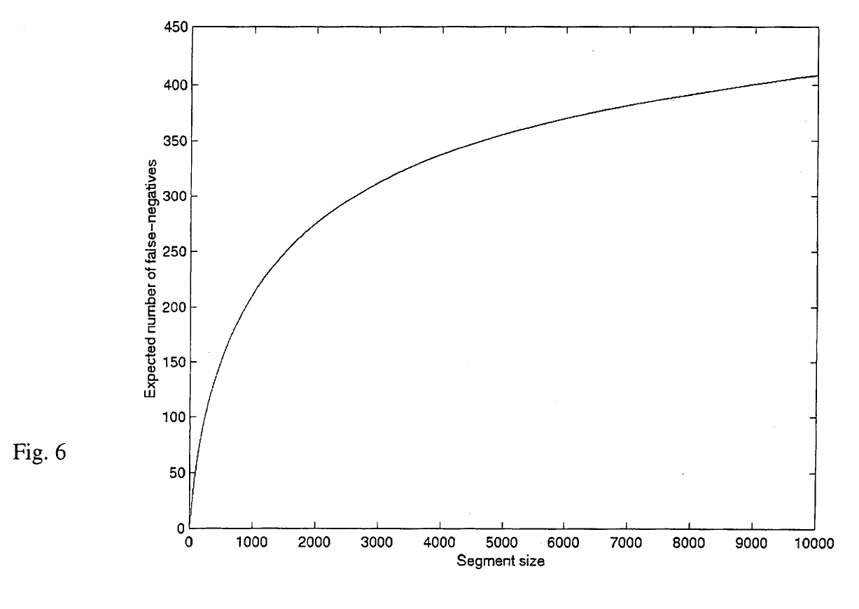

Subsequently, logistic regression analysis was applied to this set of 89530 compounds. Based on the predicted probabilities and the capacity of the assay, 1586 compounds, initially classified as inactive, were considered as potential false-negatives and suggested to the screening operators. Due to stock limitations, 1536 of the 1586 candidates were finally retested. Of the 1536 originally inactive compounds, 261 compounds, i.e. 17%, were shown to be active. The activity was then further confirmed in a dose-response experiment. The observed number of 261 false-negatives is in close agreement with the expected number of false-negatives of 254 as shown in FIG. 6 demonstrating the validity of the applied method and descriptor set. The predicted probability of the 1536 compounds ranged from 0.06 to 0.86. The mean probability of being active is 0.16, close to the final hit rate of 0.17. Considering predicted probabilities for being active greater than 0.5 as a strong indication for a compound being false negative, yielded the data summarized in Table 1. From the 63 compounds with a high predicted probability for being active, 35 (56%) were indeed active upon retesting, while from the 1474 compounds with a predicted probability <0.05 for being active, 226 (15%) were classified as active upon retesting. For the data in Table 1, the association between the predicted probability for being active and the results of the second run of the screening was highly significant (chi square 69.4, p<0.001). This finding, that the predicted probability of being active has indeed predictive power, was confirmed by computing the Spearman rank correlation between the raw %-inhibition data from the second run and the predicted probability for being active obtained from the first run. The rank correlation for the 1536 compounds was 0.36 and was highly significant (p<0.001). From FIG. 6 it is also possible to infer some statistics about the potential maximum number of false-negatives. According to that, the number of outliers is expected to be in the order of 500.

TABLE 1
Effectiveness of the invention as demonstrated by
results from the second run of the assay on 1537 compounds, initially
classified as inactive and selected on the basis of predicted probability.

| | Predicted probability for being active | | |
|---|---|---|---|
| Result of 2^{nd} run | ≦0.5 | >0.5 | Totals |
| Not Active | 1248 | 28 | 1276 |
| Active | 226 | 35 | 261 |
| Totals | 1474 | 63 | 1537 |

### EXAMPLE 2

The second example relates to the use of a neural network in conjunction with atom types as descriptors for the detection of false negatives in a second HTS experiment.

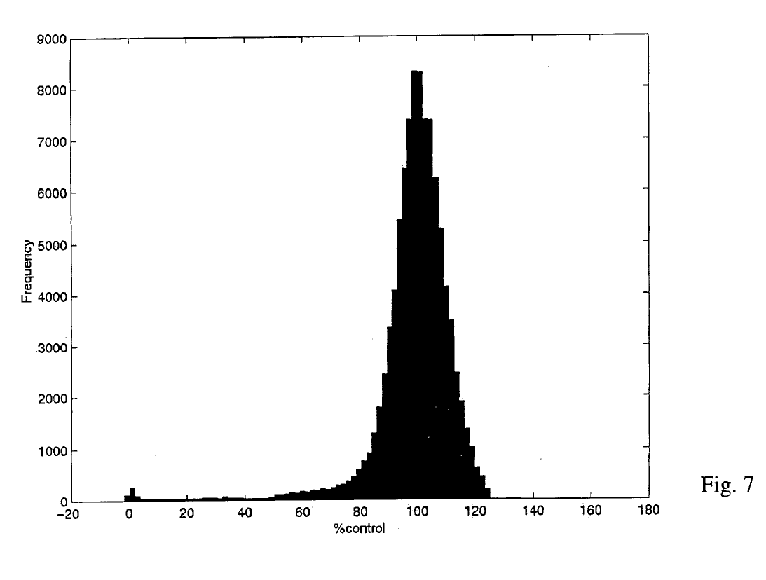

In this second assay, 98138 R-compounds were tested for their inhibitory activity on another protein target. The concentration of the test compounds was 10⁻⁵ M in the bioassay. FIG. 7 shows the distribution of the percent effect versus control values in this assay. The top 1% most active compounds were considered as active, all remaining compounds as inactive. The compounds in the data set were characterized by 72 atom types recently introduced by Wildman & Crippen. (WILDMAN, S. A. and Crippen, G. M. “Prediction of physicochemical parameters by atomic contribution” J. Chem. Inf. Comput. Sci. 1999, 39, 868-873). In contrast to the MACCS keys, the occurrence of a particular atom type is counted instead of indicating its presence or absence.

A linear seperation network, a specific type of artifical neural network, (see Weiss, S. M. and Kulikowski, C. A. Computer Systems that Learn. Morgan Kaufmaan Publishers, 1991). The neural network consisted two layers. The input layer consisted of 72 neurons (corresponds to the number of descriptors) plus one bias, and the output layer of one neuron (see C. M. Bishop, Neural Networks for Pattern Recognition, Oxford University Press, 1999). The two layers were totally connected. The neural net was trained with the descriptors as input values and the probabilities of belonging to an activity class as output values. The network used a linear combination of the inputs as combination function and a logistic activiation function.

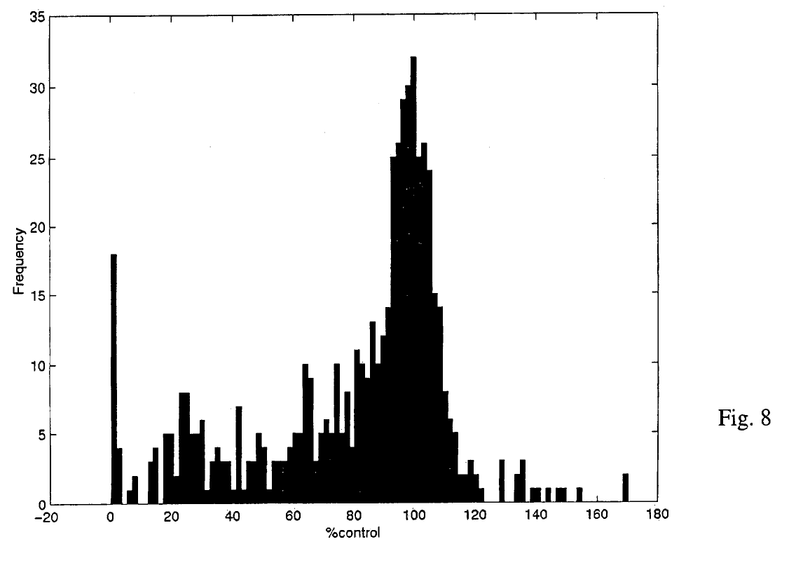

In order to derive false-negative outlier candidates, all compounds that were found active in the first screening experiment were removed from the data set. The remaining compounds are sorted according to their calculated probability to be active in descending order. Compounds with a predicted probability of being active of 10% or higher were suggested for retesting. This corresponds to the top 730 most probable compounds of the rank list. These false-negative candidates were then retested according to the original HTS protocol. FIG. 8 shows the % control profile of these 730 false-negative outlier candidates after retesting. In comparison to FIG. 7 which shows that the distribution of all compounds in the original experiment, a strong shift towards lower % control value is observed indicating that the average measured biological activity is higher in the whole population. Dose-response curves were measured for the all active compounds as well as for the 730 false-negative outlier candidates. Compounds were then categorized by an expert pharmacologist in three activity classes: highly active, medium active, and not active. Of the 745 highly active compounds that were found in the complete screening experiment—first run screening, confirmation, and outlier candidate testing—42 were obtained by the outlier detection technique in accordance with the present invention.

Finally, once the outlier candidates have been determined they can be re-tested to check the assigned activity class. Especially for false negatives the opportunity arises to consider these candidate compound objects for further study as they actually show a positive activity. The present invention includes the use of these false negatives in a pharmaceutical preparation formulated to obtain a specific biological activity for therapeutic use. However, the present invention is not limited to medical end uses but may find suitable and advantageous use in other branches of biology and/or chemistry.

What is claimed is:

1. A method of identifying an outlier candidate using a quantitative structure-activity relationship in the results of a screening assay for a set of candidate chemical objects, comprising the steps of:
forming a categorized dataset for the activity values of the candidate chemical objects;
generating a structure-activity relationship (SAR) dataset for the tested candidate chemical objects; and
analysing the SAR dataset to determine at least one outlier candidate, the outlier candidate being falsely categorized in the categorized dataset.

2. The method according to claim 1, wherein the generating step comprises:
defining a descriptor matrix for the tested candidate chemical objects; and
merging the descriptor matrix with the categorized dataset into the SAR dataset.

3. The method according to claim 1 or 2, wherein the structure-activity relationship comprises a molecular model used to describe each compound to be tested.

4. The method according to any previous claim, wherein the outlier candidate is a potential false negative or a potential false positive.

5. The method according to any of the previous claims, wherein the structure-activity relationship includes a plurality of descriptors used to describe each compound to be tested, each descriptor relating to the presence or absence of a structure fragment or physicochemical property of the relevant compound.

6. The method according to any of the previous claims, wherein the analyzing step includes a concept learning scheme.

7. The method according to claim 6, wherein the concept learning scheme includes one of regression, discriminant analysis, decision trees, and neural networks.

8. The method according to claim 7, wherein the regression analysis is logistic regression analysis.

9. The method according to any previous claim wherein the forming step comprises categorizing the activity values of the candidate chemical objects into a number of discrete classes using at least one threshold.

10. The method according to claim 9, wherein the categorizing step includes the step of automatically applying the at least one threshold based on statistical decision rules.

11. The method according to any of claims 2 to 10, wherein the defining step comprises:
selecting vectorized descriptor data for each tested candidate chemical object from a vectorized descriptor data set; and
assembling all vectors related to the tested candidate chemical objects into a matrix with each row of the matrix corresponding to a chemical object and each column corresponding to a descriptor.

12. The method according to any previous claim wherein the analyzing step includes whether the probability that a candidate chemical object belongs to a category lies outside a predetermined probability.

13. The method according to claim 12, further comprising the step of reducing the number of candidate chemical objects or descriptors depending upon their statistical relevance.

14. The method according to claim 12, wherein the reducing step comprises one of principal component analysis and factor analysis.

15. The method in accordance with any of the previous claims, wherein the chemical object is a chemical compound, a group of chemical compounds or a mixture of chemical compounds.

16. An apparatus for the identification at least one outlier candidate from the results of a screening assay for the activity of a plurality of candidate chemical objects, the apparatus comprising:
an input device for inputting a categorized dataset of biological or chemical activity values for the candidate chemical objects;
a structure-activity relationship (SAR) dataset generator;
an analyser of the SAR dataset to determine outlier candidates, the outlier candidates being those candidate chemical objects falsely categorized in the categorized dataset.

17. The apparatus according to claim 16, wherein the inputting device includes a generator for generating a categorized dataset

18. The apparatus according to claim 16 or 17, wherein the descriptor matrix generator comprises means for inputting chemical object data of candidate chemical objects, and means for generating a vectorized descriptor matrix for the candidate chemical objects.

19. The apparatus according to claim 18, wherein the SAR dataset generator comprises a structure-activity relationship (SAR) dataset generating engine for merging the vectorized descriptor matrices of the candidate chemical objects with the categorized data of the candidate chemical objects into the SAR-dataset.

20. The apparatus according to claim 19, wherein the analyzer comprises means for assigning probability values to each of the candidate chemical objects in the SAR-dataset that said candidate chemical object belongs to one activity class.

21. The apparatus according to claim 20, further comprising means of ranking the candidate chemical objects according to their probability of being incorrectly identified in an activity class.

22. Computer program product with software code portions for performing the steps of any of claims 1 to 15 when the computer program product is run on a computer.

23. A computer readable storage medium upon which is stored the computer program product as defined in claim 22.

24. An electromagnetic signal carrying the computer program product of claim 22.

25. A computer system for executing the method steps of any of the claims 1 to 15.

26. A method for the identification at least one outlier candidate in a screening assay for the biological activity of a plurality of candidate chemical objects, the candidate outlier being determined from the measured activity of each chemical object tested in the assay, comprising the steps of:
loading into a local terminal the descriptions of a plurality of chemical objects and the activity results of the assay for each chemical object;
transmitting the descriptions and activity results to a remote location for carrying out the method steps of any of the claims 1 to 15; and
receiving, at a local location, a definition of at least one outlier candidate.

27. A pharmaceutical composition including a chemical object selected as an outlier candidate in accordance with a method according to any one of the claims 1 to 15.

28. A method of identifying at least one outlier candidate in the results of a screening assay for a plurality of chemical compounds, the method comprising the steps of:
(h) generating a set of descriptors representative of at least one feature of each of the plurality of chemical compounds that were the subject of the screening assay;
(i) generating, for each of the plurality of chemical compounds, a descriptor matrix including data points each defining the predicted value of the or each feature represented by a respective descriptor;
(j) generating a corresponding empirical dataset for the chemical compounds that were the subject of the screening assay, the empirical dataset containing categorized values for the potency of each chemical compound in the assay;
(d) merging the empirical dataset with the descriptor matrix to generate a structure activity (SAR) dataset;
(e) applying a statistical analysis to the SAR dataset; and
(f) identifying, on the basis of that statistical analysis of the SAR dataset, at least one outlier candidate representing a corresponding at least one chemical compound in the empirical dataset which has been incorrectly categorized therein.

29. An apparatus for identifying at least one outlier candidate in the results of a screening assay for a plurality of chemical compounds, comprising:
a first processor for generating a set of descriptors representative of at least one feature of each of the plurality of chemical compounds that were the subject of the screening assay;
a second processor for generating, for each of the plurality of chemical compounds, a descriptor matrix including data points each defining the predicted value of the or each feature represented by a respective descriptor, and for generating a corresponding empirical dataset for the chemical compounds that were the subject of the screening assay, the empirical dataset containing categorized values for the potency of each chemical compound in the assay;
the apparatus comprising means for merging the empirical dataset with the descriptor matrix to generate a structure activity (SAR) dataset;
means for applying a statistical analysis to the SAR dataset; and
means for identifying, on the basis of that statistical analysis of the SAR dataset, at least one outlier candidate representing a corresponding at least one chemical compound in the empirical dataset which has been incorrectly categorized therein.
